(19) United States
(12) Patent Application Publication
(10) Pub. No.: US 2023/0326662 A1
(43) Pub. Date: Oct. 12, 2023

(54) LAMINATED COIL COMPONENT

(71) Applicant: Murata Manufacturing Co., Ltd., Kyoto-fu (JP)

(72) Inventors: Reiji OZAWA, Nagaokakyo-shi (JP); Shoyo YAMADA, Nagaokakyo-shi (JP); Maasa NAKANO, Nagaokakyo-shi (JP)

(73) Assignee: Murata Manufacturing Co., Ltd., Kyoto-fu (JP)

(21) Appl. No.: 18/191,868

(22) Filed: Mar. 28, 2023

(30) Foreign Application Priority Data
Mar. 30, 2022 (JP) 2022-056388

(51) Int. Cl. H01F 27/29; H01F 27/28

(52) U.S. Cl. CPC H01F 27/2804; H01F 27/292; H01F 2027/2809

(57) ABSTRACT

A laminated coil component includes an element body formed by laminating insulating layers in a lamination direction, a coil inside the body, and an external electrode on a surface of the body and electrically connected to the coil. The coil includes coil conductors laminated in the lamination direction and electrically connected via a via conductor penetrating the insulating layer in the lamination direction. The coil conductors include a laminated portion including adjacent coil conductors. The laminated portion has a parallel section in which all the coil conductors constituting the laminated portion overlap each other when viewed from the lamination direction. The parallel sections are connected in parallel by the via conductor. The coil is electrically connected to the same external electrode via lead-out conductors, each including a lead-out via conductor having a diameter of 100 µm or less and penetrating the insulating layer in the lamination direction.

### CROSS-REFERENCE TO RELATED APPLICATION

This application claims benefit of priority to Japanese Pat. Application No. 2022-056388, filed Mar. 30, 2022, the entire content of which is incorporated herein by reference.

### BACKGROUND

### Technical Field

The present disclosure relates to a laminated coil component.

### Background Art

International Publication No. WO 2015/022889 discloses an electronic component including a laminated body having a rectangular parallelepiped shape configured by laminating a plurality of insulator layers in a lamination direction. The laminated body has a first side surface formed by connecting outer edges of a plurality of the insulator layers. The electronic component also includes a coil provided on the laminated body and configured by connecting a plurality of coil conductors by a via hole conductor penetrating the insulator layer, the coil having a spiral shape traveling in the lamination direction while circulating. The electronic component further includes a first external electrode provided on at least the first side surface, and a second external electrode provided closer to the other side in the lamination direction than the first external electrode and provided on at least the first side surface, in which the coil is provided with a first parallel part configured by connecting, in parallel, at least a part of m coil conductors arranged in the lamination direction, and a second parallel part configured by connecting, in parallel, at least a part of n coil conductors arranged in the lamination direction. In this arrangement, m and n are natural numbers, n is larger than m, and a ratio of the number of the first parallel parts to the sum of the number of the first parallel parts and the number of the second parallel parts in a first region overlapping the first external electrode in plan view from a normal direction of the first side surface is higher than a ratio of the number of first parallel parts to the sum of the number of the first parallel parts and the number of the second parallel parts in a second region that does not overlap the first external electrode or the second external electrode in plan view from the normal direction of the first side surface.

### SUMMARY

FIG. 2 of International Publication No. WO 2015/022889 discloses an electronic component in which two or three coil conductors are connected in parallel. Further, in the electronic component illustrated in FIG. 2 of International Publication No. WO 2015/022889, it is described that a coil and an external electrode are connected via a lead-out conductor including a plurality of via hole conductors penetrating an insulator layer. However, as a result of examination by the present inventors, it has been found that a problem below occurs in the electronic component illustrated in FIG. 2 of International Publication No. WO 2015/022889.

In the electronic component illustrated in FIG. 2 of International Publication No. WO 2015/022889, since two or three coil conductors are connected in parallel, it is considered that a sectional area of a coil orthogonal to a direction along a current path of the coil, that is, a direction in which the coil conductor extends increases accordingly. Therefore, it is considered that in the electronic component illustrated in FIG. 2 of International Publication No. WO 2015/022889, direct current resistance (Rdc) of the coil becomes low, and large current can flow through the coil.

In the electronic component illustrated in FIG. 2 of International Publication No. WO 2015/022889, when large current is to flow through the coil, large current also flows through the lead-out conductor. In order to allow large current to easily flow through the lead-out conductor, for example, it is conceivable to reduce direct current resistance of the lead-out conductor by increasing a sectional area of the lead-out conductor orthogonal to the direction in which the lead-out conductor extends. However, when a sectional area of the via hole conductor constituting the lead-out conductor is increased in order to increase the sectional area of the lead-out conductor, the via hole conductor is more likely to be thermally shrunk than a surrounding insulator layer in a producing process of the lead-out conductor. For this reason, an exposed portion of the lead-out conductor exposed from a surface of a laminated body is recessed with respect to a surrounding insulator layer, and as a result, there arises a problem that an appearance defect occurs in the electronic component.

Accordingly, the present disclosure provides a laminated coil component in which occurrence of an appearance defect caused by a recess of an exposed portion of a lead-out conductor is reduced.

A laminated coil component of the present disclosure includes an element body formed by laminating a plurality of insulating layers in a lamination direction, a coil provided inside the element body, and an external electrode provided on a surface of the element body and electrically connected to the coil. The coil includes a plurality of coil conductors laminated in the lamination direction electrically connected via a via conductor penetrating the insulating layer in the lamination direction. The plurality of the coil conductors laminated in the lamination direction includes a laminated portion including a plurality of the coil conductors adjacent to each other. The laminated portion has a parallel section in which all the coil conductors constituting the laminated portion overlap each other when viewed from the lamination direction. The parallel sections are connected in parallel by the via conductor. The coil is electrically connected to the same external electrode via a plurality of lead-out conductors. Each of the lead-out conductors includes a lead-out via conductor penetrating the insulating layer in the lamination direction, and a diameter of the lead-out via conductor is 100 µm or less.

According to the present disclosure, it is possible to provide a laminated coil component in which occurrence of appearance defects due to a recess of an exposed portion of a lead-out conductor is reduced.

### BRIEF DESCRIPTION OF THE DRAWINGS

FIG. 1 is a schematic perspective view illustrating an example of a laminated coil component of the present disclosure;

FIG. 2 is a schematic perspective view illustrating an example of a state in which the laminated coil component illustrated in FIG. 1 (where an external electrode is excluded) is disassembled;

FIG. 3 is a schematic plan view illustrating an example of a state in which the laminated coil component illustrated in FIG. 1 (where an external electrode is excluded) is disassembled;

FIG. 4 is an enlarged schematic sectional view illustrating an example of a state in which the vicinity of a first end surface of an element body is viewed in a sectional view from a height direction in the laminated coil component illustrated in FIG. 1;

FIG. 5 is an enlarged schematic sectional view illustrating an example of a state in which the vicinity of a second end surface of the element body is viewed in a sectional view from the height direction in the laminated coil component illustrated in FIG. 1; and

FIG. 6 is an enlarged schematic sectional view illustrating an example of a state in which three coil conductors constituting a parallel section are viewed in a sectional view from a height direction in the laminated coil component illustrated in FIGS. 2 and 3.

### DETAILED DESCRIPTION

Hereinafter, a laminated coil component of the present disclosure will be described. The present disclosure is not limited to a configuration below, and may be modified as appropriate without departing from the gist of the present disclosure. Further, a combination of a plurality of individual preferable configurations described below is also the present disclosure.

The drawings shown below are schematic views, and dimensions, scales of aspect ratios, and the like may be different from those of an actual product.

A laminated coil component of the present disclosure includes an element body formed by laminating a plurality of insulating layers in a lamination direction, a coil provided inside the element body, and an external electrode provided on a surface of the element body and electrically connected to the coil. The coil includes a plurality of coil conductors laminated in the lamination direction electrically connected via a via conductor penetrating the insulating layer in the lamination direction. The plurality of the coil conductors laminated in the lamination direction includes a laminated portion including a plurality of the coil conductors adjacent to each other. The laminated portion has a parallel section in which all the coil conductors constituting the laminated portion overlap each other when viewed from the lamination direction. The parallel sections are connected in parallel by the via conductor. The coil is electrically connected to the same external electrode via a plurality of lead-out conductors. Each of the lead-out conductors includes a lead-out via conductor penetrating the insulating layer in the lamination direction, and a diameter of the lead-out via conductor is 100 µm or less.

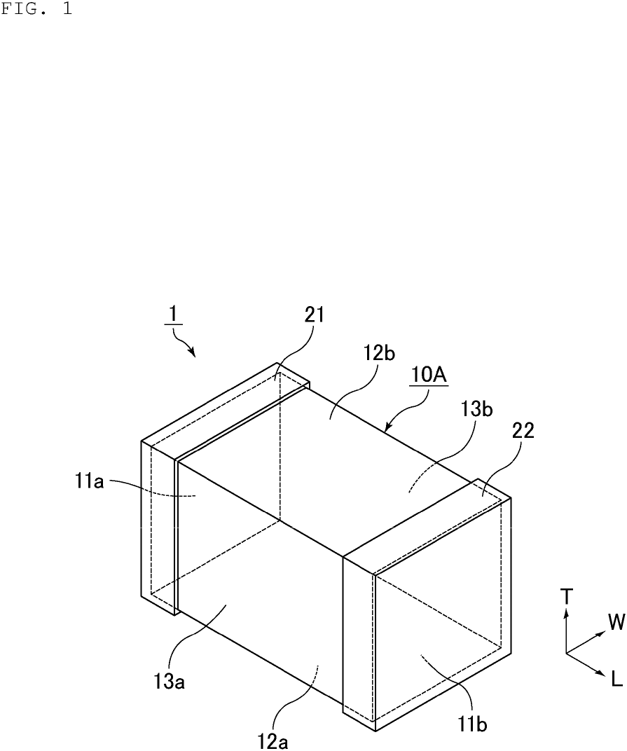

FIG. 1 is a schematic perspective view illustrating an example of the laminated coil component of the present disclosure.

A laminated coil component 1 illustrated in FIG. 1 includes an element body 10A, a first external electrode 21, and a second external electrode 22. Although not illustrated in FIG. 1, as described later, the laminated coil component 1 also includes a coil provided inside the element body 10A.

In the present description, a length direction, a height direction, and a width direction are respectively defined as L, T, and W, according to FIG. 1 and the like. Here, the length direction L, the height direction T, and the width direction W are orthogonal to each other.

The element body 10A has a first end surface 11a and a second end surface 11b facing each other in the length direction L, a first main surface 12a and a second main surface 12b facing each other in the height direction T, and a first side surface 13a and a second side surface 13b facing each other in the width direction W, and has, for example, a rectangular parallelepiped shape or a substantially rectangular parallelepiped shape.

The first end surface 11a and the second end surface 11b of the element body 10A do not need to be strictly orthogonal to the length direction L. Further, the first main surface 12a and the second main surface 12b of the element body 10A do not need to be strictly orthogonal to the height direction T. Furthermore, the first side surface 13a and the second side surface 13b of the element body 10A do not need to be strictly orthogonal to the width direction W.

In a case where the laminated coil component 1 is mounted on a substrate, the first main surface 12a of the element body 10A serves as a mounting surface.

The element body 10A preferably has a corner portion and a ridge portion that are rounded. The corner portion of the element body 10A is a portion where three surfaces of the element body 10A intersect. The ridge portion of the element body 10A is a portion where two surfaces of the element body 10A intersect.

The first external electrode 21 is provided on a surface of the element body 10A. More specifically, the first external electrode 21 extends from the first end surface 11a of the element body 10A over a part of each of the first main surface 12a, the second main surface 12b, the first side surface 13a, and the second side surface 13b.

An arrangement mode of the first external electrode 21 is not limited to a mode illustrated in FIG. 1. For example, the first external electrode 21 may extend from a part of the first main surface 12a of the element body 10A to a part of each of the first end surface 11a, the first side surface 13a, and the second side surface 13b.

The second external electrode 22 is provided on a surface of the element body 10A. More specifically, the second external electrode 22 extends from the second end surface 11b of the element body 10A over a part of each of the first main surface 12a, the second main surface 12b, the first side surface 13a, and the second side surface 13b.

An arrangement mode of the second external electrode 22 is not limited to the mode illustrated in FIG. 1. For example, the second external electrode 22 may extend from a part of the first main surface 12a of the element body 10A to a part of each of the second end surface 11b, the first side surface 13a, and the second side surface 13b.

As described above, the first external electrode 21 and the second external electrode 22 are provided at positions separated from each other on a surface of the element body 10A.

As described above, since the first external electrode 21 and the second external electrode 22 are provided on the first main surface 12a of the element body 10A as a mounting surface, mountability of the laminated coil component 1 is improved.

Each of the first external electrode 21 and the second external electrode 22 may have a single-layer structure or a multilayer structure.

In a case where each of the first external electrode 21 and the second external electrode 22 has a single-layer structure, examples of a constituent material of each of the external electrodes include Ag, Au, Cu, Pd, Ni, Al, an alloy containing at least one of these types of metal, and the like.

In a case where each of the first external electrode 21 and the second external electrode 22 has a multilayer structure, each of the external electrodes may have, for example, a base electrode containing Ag, a Ni plated electrode, and a Sn plated electrode in this order from the surface side of the element body 10A.

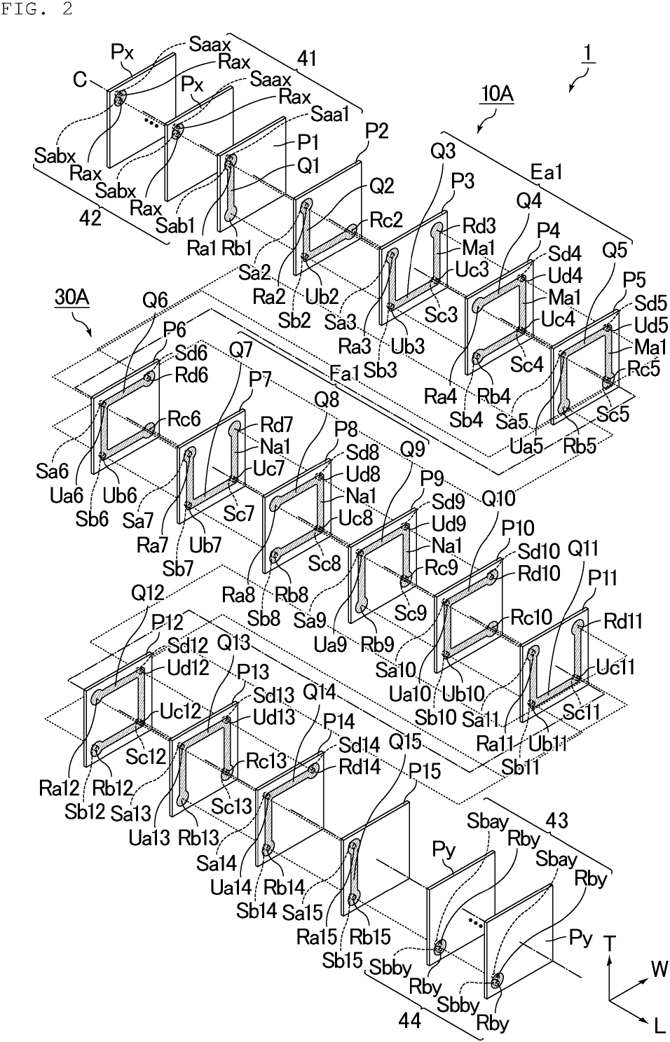

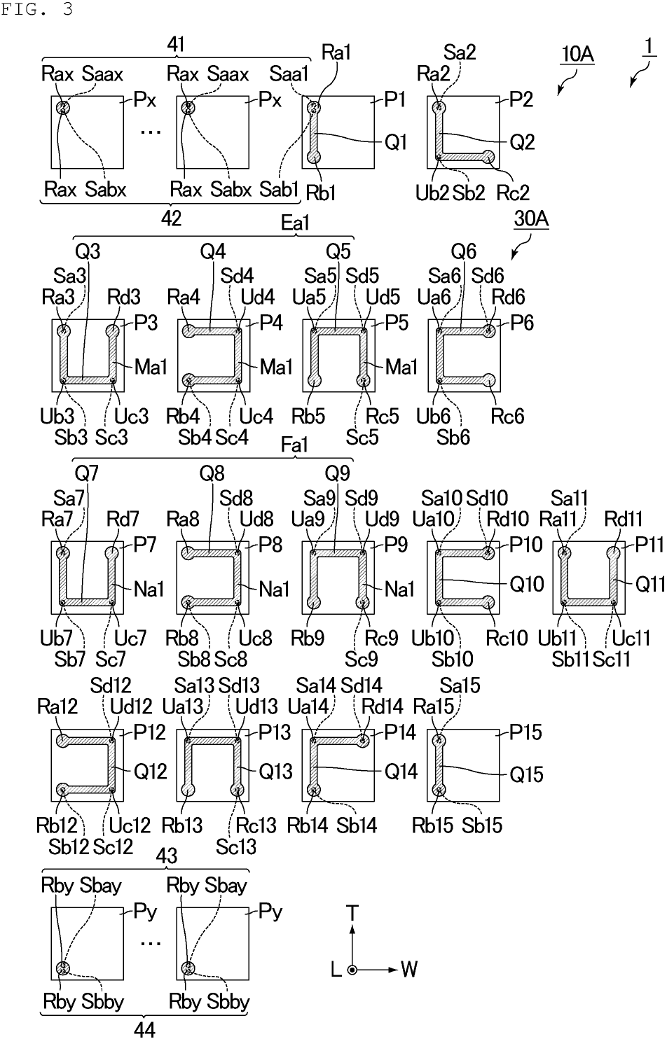

FIG. 2 is a schematic perspective view illustrating an example of a state in which the laminated coil component illustrated in FIG. 1 (where an external electrode is excluded) is disassembled. FIG. 3 is a schematic plan view illustrating an example of a state in which the laminated coil component illustrated in FIG. 1 (where an external electrode is excluded) is disassembled.

As illustrated in FIGS. 2 and 3, the element body 10A includes a plurality of insulating layers laminated in a lamination direction, here, the length direction L.

The element body 10A includes an insulating layer P1, an insulating layer P2, an insulating layer P3, an insulating layer P4, an insulating layer P5, an insulating layer P6, an insulating layer P7, an insulating layer P8, an insulating layer P9, an insulating layer P10, an insulating layer P11, an insulating layer P12, an insulating layer P13, an insulating layer P14, and an insulating layer P15 in order in the length direction L from the first end surface 11a side toward the second end surface 11b side.

Examples of a constituent material of each insulating layer include a magnetic material such as a ferrite material.

The ferrite material is preferably a Ni-Cu-Zn-based ferrite material.

The Ni-Cu-Zn-based ferrite material preferably contains Fe in an amount of 40 mol% or more and 49.5 mol% or less (i.e., from 40 mol% to 49.5 mol%) in terms of Fe₂O₃, Zn in an amount of 2 mol% or more and 35 mol% or less (i.e., from 2 mol% to 35 mol%) in terms of ZnO, Cu in an amount of 6 mol% or more and 13 mol% or less (i.e., from 6 mol% to 13 mol%) in terms of CuO, and Ni in an amount of 10 mol% or more and 45 mol% or less (i.e., from 10 mol% to 45 mol%) in terms of NiO when the total amount is 100 mol%.

The Ni-Cu-Zn-based ferrite material may further contain an additive such as Co, Bi, Sn, or Mn.

The Ni-Cu-Zn-based ferrite material may further contain inevitable impurities.

A coil 30A is provided inside the element body 10A.

As illustrated in FIGS. 2 and 3, the coil 30A includes a coil conductor Q1, a coil conductor Q2, a coil conductor Q3, a coil conductor Q4, a coil conductor Q5, a coil conductor Q6, a coil conductor Q7, a coil conductor Q8, a coil conductor Q9, a coil conductor Q10, a coil conductor Q11, a coil conductor Q12, a coil conductor Q13, a coil conductor Q14, and a coil conductor Q15 in order in the length direction L.

The coil conductor Q1 is linear and provided on a main surface of the insulating layer P1.

The coil conductor Q1 has a land portion Ra1 and a land portion Rb1 at different end portions.

The coil conductor Q2 has an L shape and is provided on a main surface of the insulating layer P2.

The coil conductor Q2 has a land portion Ra2 and a land portion Rc2 at different end portions.

The land portion Ra2 is connected to a via conductor Sa2 penetrating the insulating layer P2 in the length direction L. The via conductor Sa2 is connected to the land portion Ra1 in addition to the land portion Ra2. That is, the land portion Ra1 and the land portion Ra2 are electrically connected via the via conductor Sa2.

The coil conductor Q2 has a bent portion Ub2.

The bent portion Ub2 is connected to a via conductor Sb2 penetrating the insulating layer P2 in the length direction L. The via conductor Sb2 is connected to the land portion Rb1 in addition to the bent portion Ub2. That is, the land portion Rb1 and the bent portion Ub2 are electrically connected via the via conductor Sb2.

The coil conductor Q3 has a U shape and is provided on a main surface of the insulating layer P3.

The coil conductor Q3 has a land portion Ra3 and a land portion Rd3 at different end portions.

The land portion Ra3 is connected to a via conductor Sa3 penetrating the insulating layer P3 in the length direction L. The via conductor Sa3 is connected to the land portion Ra2 in addition to the land portion Ra3. That is, the land portion Ra2 and the land portion Ra3 are electrically connected via the via conductor Sa3.

The coil conductor Q3 has a bent portion Ub3 and a bent portion Uc3.

The bent portion Ub3 is connected to the via conductor Sb3 penetrating the insulating layer P3 in the length direction L. The via conductor Sb3 is connected to the bent portion Ub2 in addition to the bent portion Ub3. That is, the bent portion Ub2 and the bent portion Ub3 are electrically connected via the via conductor Sb3.

The bent portion Uc3 is connected to a via conductor Sc3 penetrating the insulating layer P3 in the length direction L. The via conductor Sc3 is connected to the land portion Rc2 in addition to the bent portion Uc3. That is, the land portion Rc2 and the bent portion Uc3 are electrically connected via the via conductor Sc3.

The coil conductor Q4 has a U shape and is provided on a main surface of the insulating layer P4.

The coil conductor Q4 has a land portion Ra4 and a land portion Rb4 at different end portions.

The land portion Rb4 is connected to a via conductor Sb4 penetrating the insulating layer P4 in the length direction L. The via conductor Sb4 is connected to the bent portion Ub3 in addition to the land portion Rb4. That is, the bent portion Ub3 and the land portion Rb4 are electrically connected via the via conductor Sb4.

The coil conductor Q4 has a bent portion Uc4 and a bent portion Ud4.

The bent portion Uc4 is connected to a via conductor Sc4 penetrating the insulating layer P4 in the length direction L. The via conductor Sc4 is connected to the bent portion Uc3 in addition to the bent portion Uc4. That is, the bent portion Uc3 and the bent portion Uc4 are electrically connected via the via conductor Sc4.

The bent portion Ud4 is connected to a via conductor Sd4 penetrating the insulating layer P4 in the length direction L. The via conductor Sd4 is connected to the land portion Rd3 in addition to the bent portion Ud4. That is, the land portion Rd3 and the bent portion Ud4 are electrically connected via the via conductor Sd4.

The coil conductor Q5 has a U shape and is provided on a main surface of the insulating layer P5.

The coil conductor Q5 has a land portion Rb5 and a land portion Rc5 at different end portions.

The land portion Rc5 is connected to a via conductor Sc5 penetrating the insulating layer P5 in the length direction L. The via conductor Sc5 is connected to the bent portion Uc4 in addition to the land portion Rc5. That is, the bent portion Uc4 and the land portion Rc5 are electrically connected via the via conductor Sc5.

The coil conductor Q5 has a bent portion Ua5 and a bent portion Ud5.

The bent portion Ua5 is connected to a via conductor Sa5 penetrating the insulating layer P5 in the length direction L. The via conductor Sa5 is connected to the land portion Ra4 in addition to the bent portion Ua5. That is, the land portion Ra4 and the bent portion Ua5 are electrically connected via the via conductor Sa5.

The bent portion Ud5 is connected to a via conductor Sd5 penetrating the insulating layer P5 in the length direction L. The via conductor Sd5 is connected to the bent portion Ud4 in addition to the bent portion Ud5. That is, the bent portion Ud4 and the bent portion Ud5 are electrically connected via the via conductor Sd5.

The coil conductor Q6 has a U shape and is provided on a main surface of the insulating layer P6.

The coil conductor Q6 has a land portion Rc6 and a land portion Rd6 at different end portions.

The land portion Rd6 is connected to a via conductor Sd6 penetrating the insulating layer P6 in the length direction L. The via conductor Sd6 is connected to the bent portion Ud5 in addition to the land portion Rd6. That is, the bent portion Ud5 and the land portion Rd6 are electrically connected via the via conductor Sd6.

The coil conductor Q6 has a bent portion Ua6 and a bent portion Ub6.

The bent portion Ua6 is connected to a via conductor Sa6 penetrating the insulating layer P6 in the length direction L. The via conductor Sa6 is connected to the bent portion Ua5 in addition to the bent portion Ua6. That is, the bent portion Ua5 and the bent portion Ua6 are electrically connected via the via conductor Sa6.

The bent portion Ub6 is connected to a via conductor Sb6 penetrating the insulating layer P6 in the length direction L. The via conductor Sb6 is connected to the land portion Rb5 in addition to the bent portion Ub6. That is, the land portion Rb5 and the bent portion Ub6 are electrically connected via the via conductor Sb6.

The coil conductor Q7 has a U shape and is provided on a main surface of the insulating layer P7.

The coil conductor Q7 has a land portion Ra7 and a land portion Rd7 at different end portions.

The land portion Ra7 is connected to a via conductor Sa7 penetrating the insulating layer P7 in the length direction L. The via conductor Sa7 is connected to the bent portion Ua6 in addition to the land portion Ra7. That is, the bent portion Ua6 and the land portion Ra7 are electrically connected via the via conductor Sa7.

The coil conductor Q7 has a bent portion Ub7 and a bent portion Uc7.

The bent portion Ub7 is connected to a via conductor Sb7 penetrating the insulating layer P7 in the length direction L. The via conductor Sb7 is connected to the bent portion Ub6 in addition to the bent portion Ub7. That is, the bent portion Ub6 and the bent portion Ub7 are electrically connected via the via conductor Sb7.

The bent portion Uc7 is connected to a via conductor Sc7 penetrating the insulating layer P7 in the length direction L. The via conductor Sc7 is connected to the land portion Rc6 in addition to the bent portion Uc7. That is, the land portion Rc6 and the bent portion Uc7 are electrically connected via the via conductor Sc7.

The coil conductor Q8 has a U shape and is provided on a main surface of the insulating layer P8.

The coil conductor Q8 has a land portion Ra8 and a land portion Rb8 at different end portions.

The land portion Rb8 is connected to a via conductor Sb8 penetrating the insulating layer P8 in the length direction L. The via conductor Sb8 is connected to the bent portion Ub7 in addition to the land portion Rb8. That is, the bent portion Ub7 and the land portion Rb8 are electrically connected via the via conductor Sb8.

The coil conductor Q8 has a bent portion Uc8 and a bent portion Ud8.

The bent portion Uc8 is connected to a via conductor Sc8 penetrating the insulating layer P8 in the length direction L. The via conductor Sc8 is connected to the bent portion Uc7 in addition to the bent portion Uc8. That is, the bent portion Uc7 and the bent portion Uc8 are electrically connected via the via conductor Sc8.

The bent portion Ud8 is connected to a via conductor Sd8 penetrating the insulating layer P8 in the length direction L. The via conductor Sd8 is connected to the land portion Rd7 in addition to the bent portion Ud8. That is, the land portion Rd7 and the bent portion Ud8 are electrically connected via the via conductor Sd8.

The coil conductor Q9 has a U shape and is provided on a main surface of the insulating layer P9.

The coil conductor Q9 has a land portion Rb9 and a land portion Rc9 at different end portions.

The land portion Rc9 is connected to a via conductor Sc9 penetrating the insulating layer P9 in the length direction L. The via conductor Sc9 is connected to the bent portion Uc8 in addition to the land portion Rc9. That is, the bent portion Uc8 and the land portion Rc9 are electrically connected via the via conductor Sc9.

The coil conductor Q9 has a bent portion Ua9 and a bent portion Ud9.

The bent portion Ua9 is connected to a via conductor Sa9 penetrating the insulating layer P9 in the length direction L. The via conductor Sa9 is connected to the land portion Ra8 in addition to the bent portion Ua9. That is, the land portion Ra8 and the bent portion Ua9 are electrically connected via the via conductor Sa9.

The bent portion Ud9 is connected to a via conductor Sd9 penetrating the insulating layer P9 in the length direction L. The via conductor Sd9 is connected to the bent portion Ud8 in addition to the bent portion Ud9. That is, the bent portion Ud8 and the bent portion Ud9 are electrically connected via the via conductor Sd9.

The coil conductor Q10 has a U shape and is provided on a main surface of the insulating layer P10.

The coil conductor Q10 has a land portion Rc10 and a land portion Rd10 at different end portions.

The land portion Rd10 is connected to a via conductor Sd10 penetrating the insulating layer P10 in the length direction L. The via conductor Sd10 is connected to the bent portion Ud9 in addition to the land portion Rd10. That is, the bent portion Ud9 and the land portion Rd10 are electrically connected via the via conductor Sd10.

The coil conductor Q10 has a bent portion Ua10 and a bent portion Ub10.

The bent portion Ua10 is connected to a via conductor Sa10 penetrating the insulating layer P10 in the length direction L. The via conductor Sa10 is connected to the bent portion Ua9 in addition to the bent portion Ua10. That is, the bent portion Ua9 and the bent portion Ua10 are electrically connected via the via conductor Sa10.

The bent portion Ub10 is connected to a via conductor Sb10 penetrating the insulating layer P10 in the length direction L. The via conductor Sb10 is connected to the land portion Rb9 in addition to the bent portion Ub10. That is, the land portion Rb9 and the bent portion Ub10 are electrically connected via the via conductor Sb10.

The coil conductor Q11 has a U shape and is provided on a main surface of the insulating layer P11.

The coil conductor Q11 has a land portion Ra11 and a land portion Rd11 at different end portions.

The land portion Ra11 is connected to a via conductor Sa11 penetrating the insulating layer P11 in the length direction L. The via conductor Sa11 is connected to the bent portion Ua10 in addition to the land portion Ra11. That is, the bent portion Ua10 and the land portion Ra11 are electrically connected via the via conductor Sa11.

The coil conductor Q11 has a bent portion Ub11 and a bent portion Uc11.

The bent portion Ub11 is connected to a via conductor Sb11 penetrating the insulating layer P11 in the length direction L. The via conductor Sb11 is connected to the bent portion Ub10 in addition to the bent portion Ub11. That is, the bent portion Ub10 and the bent portion Ub11 are electrically connected via the via conductor Sb11.

The bent portion Uc11 is connected to a via conductor Sc11 penetrating the insulating layer P11 in the length direction L. The via conductor Sc11 is connected to the land portion Rc10 in addition to the bent portion Uc11. That is, the land portion Rc10 and the bent portion Uc11 are electrically connected via the via conductor Sc11.

The coil conductor Q12 has a U shape and is provided on a main surface of the insulating layer P12.

The coil conductor Q12 has a land portion Ra12 and a land portion Rb12 at different end portions.

The land portion Rb12 is connected to a via conductor Sb12 penetrating the insulating layer P12 in the length direction L. The via conductor Sb12 is connected to the bent portion Ub11 in addition to the land portion Rb12. That is, the bent portion Ub11 and the land portion Rb12 are electrically connected via the via conductor Sb12.

The coil conductor Q12 has a bent portion Uc12 and a bent portion Ud12.

The bent portion Uc12 is connected to a via conductor Sc12 penetrating the insulating layer P12 in the length direction L. The via conductor Sc12 is connected to the bent portion Uc11 in addition to the bent portion Uc12. That is, the bent portion Uc11 and the bent portion Uc12 are electrically connected via the via conductor Sc12.

The bent portion Ud12 is connected to a via conductor Sd12 penetrating the insulating layer P12 in the length direction L. The via conductor Sd12 is connected to the land portion Rd11 in addition to the bent portion Ud12. That is, the land portion Rd11 and the bent portion Ud12 are electrically connected via the via conductor Sd12.

The coil conductor Q13 has a U shape and is provided on a main surface of the insulating layer P13.

The coil conductor Q13 has a land portion Rb13 and a land portion Rc13 at different end portions.

The land portion Rc13 is connected to a via conductor Sc13 penetrating the insulating layer P13 in the length direction L. The via conductor Sc13 is connected to the bent portion Uc12 in addition to the land portion Rc13. That is, the bent portion Uc12 and the land portion Rc13 are electrically connected via the via conductor Sc13.

The coil conductor Q13 has a bent portion Ua13 and a bent portion Ud13.

The bent portion Ua13 is connected to a via conductor Sa13 penetrating the insulating layer P13 in the length direction L. The via conductor Sa13 is connected to the land portion Ra12 in addition to the bent portion Ua13. That is, the land portion Ra12 and the bent portion Ua13 are electrically connected via the via conductor Sa13.

The bent portion Ud13 is connected to a via conductor Sd13 penetrating the insulating layer P13 in the length direction L. The via conductor Sd13 is connected to the bent portion Ud12 in addition to the bent portion Ud13. That is, the bent portion Ud12 and the bent portion Ud13 are electrically connected via the via conductor Sd13.

The coil conductor Q14 has an L shape and is provided on a main surface of the insulating layer P14.

The coil conductor Q14 has a land portion Rb14 and a land portion Rd14 at different end portions.

The land portion Rb14 is connected to a via conductor Sb14 penetrating the insulating layer P14 in the length direction L. The via conductor Sb14 is connected to the land portion Rb13 in addition to the land portion Rb14. That is, the land portion Rb13 and the land portion Rb14 are electrically connected via the via conductor Sb14.

The land portion Rd14 is connected to a via conductor Sd14 penetrating the insulating layer P14 in the length direction L. The via conductor Sd14 is connected to the bent portion Ud13 in addition to the land portion Rd14. That is, the bent portion Ud13 and the land portion Rd14 are electrically connected via the via conductor Sd14.

The coil conductor Q14 has a bent portion Ua14.

The bent portion Ua14 is connected to a via conductor Sa14 penetrating the insulating layer P14 in the length direction L. The via conductor Sa14 is connected to the bent portion Ua13 in addition to the bent portion Ua14. That is, the bent portion Ua13 and the bent portion Ua14 are electrically connected via the via conductor Sa14.

The coil conductor Q15 has a linear shape and is provided on a main surface of the insulating layer P15.

The coil conductor Q15 has a land portion Ra15 and a land portion Rb15 at different end portions.

The land portion Ra15 is connected to a via conductor Sa15 penetrating the insulating layer P15 in the length direction L. The via conductor Sa15 is connected to the bent portion Ua14 in addition to the land portion Ra15. That is, the bent portion Ua14 and the land portion Ra15 are electrically connected via the via conductor Sa15.

The land portion Rb15 is connected to a via conductor Sb15 penetrating the insulating layer P15 in the length direction L. The via conductor Sb15 is connected to the land portion Rb14 in addition to the land portion Rb15. That is, the land portion Rb14 and the land portion Rb15 are electrically connected via the via conductor Sb15.

In the present description, the L shape only needs to be a shape in which two sides are substantially orthogonal to each other, and does not need to be a shape in which two sides are strictly orthogonal to each other.

In the present description, the U shape only needs to be a shape in which two adjacent sides of three sides are substantially orthogonal to each other, and does not need to be a shape in which two adjacent sides of three sides are strictly orthogonal to each other.

In the laminated coil component 1, as described above, the insulating layer P1, the insulating layer P2, the insulating layer P3, the insulating layer P4, the insulating layer P5, the insulating layer P6, the insulating layer P7, the insulating layer P8, the insulating layer P9, the insulating layer P10, the insulating layer P11, the insulating layer P12, the insulating layer P13, the insulating layer P14, and the insulating layer P15 are laminated in order in the length direction L. By the above, the coil conductor Q1, the coil conductor Q2, the coil conductor Q3, the coil conductor Q4, the coil conductor Q5, the coil conductor Q6, the coil conductor Q7, the coil conductor Q8, the coil conductor Q9, the coil conductor Q10, the coil conductor Q11, the coil conductor Q12, the coil conductor Q13, the coil conductor Q14, and the coil conductor Q15 are electrically connected via the via conductors described above while being laminated in order in the length direction L together with the insulating layer, and as a result, the coil 30A is configured.

The coil 30A has, for example, a solenoid shape.

When viewed from the length direction L, the coil 30A may have a shape constituted by a straight portion (for example, a polygonal shape) as illustrated in FIGS. 2 and 3, a shape constituted by a curved portion (for example, a circular shape), or a shape constituted by a straight portion and a curved portion.

In the laminated coil component of the present disclosure, the lamination direction and a direction of a coil axis of the coil are preferably parallel to a mounting surface of the element body along the same direction.

In the element body 10A, the lamination direction of the insulating layer is parallel to the length direction L. That is, the lamination direction of the insulating layer is parallel to the first main surface 12a of the element body 10A which is a mounting surface.

The coil 30A has a coil axis C. The coil axis C of the coil 30A corresponds to a central axis of the coil 30A when viewed from the length direction L, and extends in the length direction L. That is, a direction of the coil axis C of the coil 30A is parallel to the first main surface 12a of the element body 10A which is a mounting surface.

Therefore, in the laminated coil component 1, the lamination direction of the insulating layer and the direction of the coil axis C of the coil 30A are parallel to the first main surface 12a of the element body 10A as a mounting surface along the same length direction L.

In the laminated coil component 1, a mode in which the lamination direction of the insulating layer and the direction of the coil axis C of the coil 30A are parallel to the first main surface 12a of the element body 10A as a mounting surface along the same length direction L. However, the lamination direction of the insulating layer and the direction of the coil axis of the coil may be orthogonal to the first main surface of the element body as a mounting surface.

In the laminated coil component 1, a plurality of coil conductors laminated in the length direction L include a first laminated portion Ea1.

The first laminated portion Ea1 includes three of the coil conductors Q3, Q4, and Q5 adjacent to each other.

The first laminated portion Ea1 has a first parallel section Ma1 in which all the coil conductors constituting the first laminated portion Ea1, that is, the coil conductor Q3, the coil conductor Q4, and the coil conductor Q5 overlap each other when viewed from the length direction L.

The first parallel sections Ma1 are connected in parallel by the via conductor Sc4, the via conductor Sd4, the via conductor Sc5, and the via conductor Sd5. That is, the coil conductor Q3, the coil conductor Q4, and the coil conductor Q5 are connected in parallel in the first parallel sections Ma1.

All of the coil conductor Q3, the coil conductor Q4, and the coil conductor Q5 do not overlap each other when viewed from the length direction L in a section other than the first parallel section Ma1.

In the laminated coil component 1, a plurality of coil conductors laminated in the length direction L further include a second laminated portion Fa1 in addition to the first laminated portion Ea1.

The second laminated portion Fa1 includes three of the coil conductors Q7, Q8, and Q9 adjacent to each other which are as many as the coil conductors in the first laminated portion Ea1 (i.e., a number of the coil conductors Q7, Q8 and Q9 in the second laminated portion Fa1 is the same as the number of the coil conductors Q3, Q4 and Q5 in the first laminated portion Ea1).

The second laminated portion Fa1 has a second parallel section Na1 in which all the coil conductors constituting the second laminated portion Fa1, that is, the coil conductor Q7, the coil conductor Q8, and the coil conductor Q9 overlap each other when viewed from the length direction L.

The second parallel sections Na1 are connected in parallel by the via conductor Sc8, the via conductor Sd8, the via conductor Sc9, and the via conductor Sd9. That is, the coil conductor Q7, the coil conductor Q8, and the coil conductor Q9 are connected in parallel in the second parallel sections Na1.

All of the coil conductor Q7, the coil conductor Q8, and the coil conductor Q9 do not overlap each other when viewed from the length direction L in a section other than the second parallel section Na1.

The first parallel section Ma1 and the second parallel section Na1 overlap each other when viewed from the length direction L.

In the above description, in the laminated coil component 1, the first laminated portion Ea1 and the second laminated portion Fa1 are exemplified as laminated portions including three coil conductors adjacent to each other, but the same applies to laminated portions including another combination of three coil conductors adjacent to each other. That is, in the laminated coil component 1, three coil conductors adjacent to each other are connected in parallel in a parallel section in which the coil conductors overlap each other when viewed from the length direction L.

In the laminated coil component 1, since three coil conductors adjacent to each other are connected in parallel in a parallel section, a sectional area of the coil 30A orthogonal to a direction along a current path of the coil 30A, that is, a direction in which the coil conductor extends increases accordingly. Therefore, in the laminated coil component 1, direct current resistance (Rdc) of the coil 30A becomes low, and large current can flow through the coil 30A.

In the laminated coil component of the present disclosure, a length of all the coil conductors constituting the laminated portion may be a length of ¾ turns of the coil.

In the laminated coil component 1, for example, a length of all the coil conductors constituting the first laminated portion Ea1 is a length of ¾ turns of the coil 30A. Further, in the laminated coil component 1, for example, a length of all the coil conductors constituting the second laminated portion Fa1 is a length of ¾ turns of the coil 30A.

In the present description, a length of the coil conductor means a length in a direction in which the coil conductor extends on a plane orthogonal to the lamination direction when viewed from the lamination direction (the length direction L in FIGS. 2 and 3).

The element body 10A further includes an insulating layer Px.

The insulating layer Px is laminated on the first end surface 11a side of the insulating layer P1, that is, on the side of the insulating layer P1 opposite to the insulating layer P2.

On a main surface of the insulating layer Px, a lead-out land portion Rax is provided. The lead-out land portion Rax is connected to a lead-out via conductor Saax penetrating the insulating layer Px in the length direction L. In addition to the lead-out via conductor Saax, the lead-out land portion Rax is also connected to a lead-out via conductor Saa1 penetrating the insulating layer P1 in the length direction L. By the above, a first lead-out conductor 41 including the lead-out land portion Rax, the lead-out via conductor Saax, and the lead-out via conductor Saa1 is configured.

The lead-out via conductor Saa1 is connected to the land portion Ra1 in addition to the lead-out land portion Rax. That is, the first lead-out conductor 41 is connected to the coil 30A.

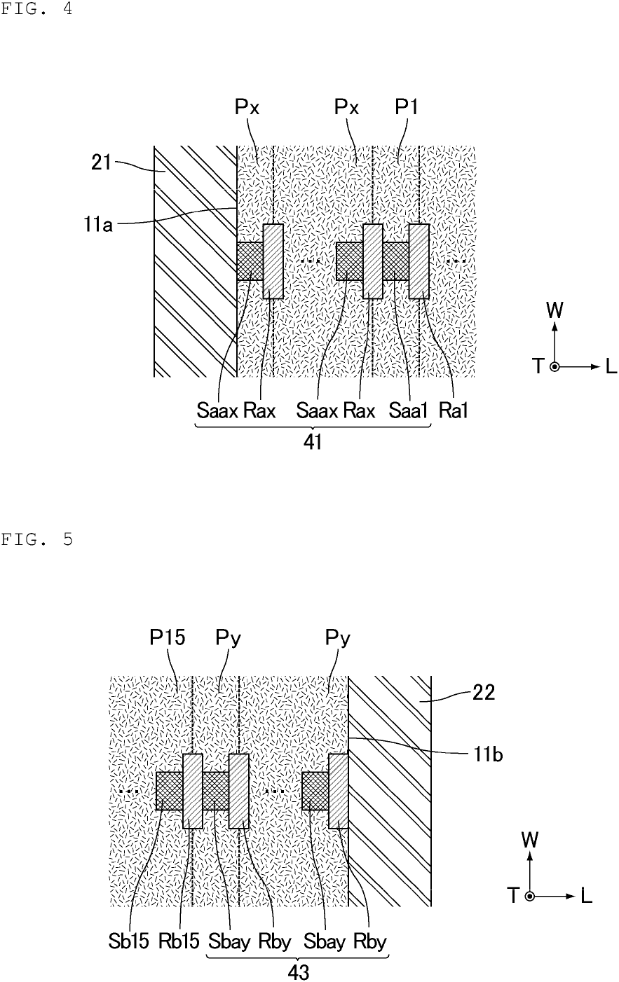

FIG. 4 is an enlarged schematic sectional view illustrating an example of a state in which the vicinity of a first end surface of an element body is viewed in a sectional view from the height direction in the laminated coil component illustrated in FIG. 1.

As illustrated in FIG. 4, since the insulating layer Px is laminated on the insulating layer P1 on the side opposite to the insulating layer P2, the first lead-out conductor 41 is exposed from the first end surface 11a of the element body 10A. The exposed portion of the first lead-out conductor 41 is connected to the first external electrode 21 provided on the first end surface 11a of the element body 10A.

Therefore, the coil 30A and the first external electrode 21 are electrically connected via the first lead-out conductor 41.

Note that, in FIG. 4, boundaries between the insulating layers are illustrated for convenience of description, but these boundaries do not clearly appear in practice.

The lead-out land portion Rax is connected to a lead-out via conductor Sabx that is provided separately from the lead-out via conductor Saax and penetrates the insulating layer Px in the length direction L. In addition to the lead-out via conductor Sabx, the lead-out land portion Rax is also connected to a lead-out via conductor Sab1 penetrating the insulating layer P1 in the length direction L. By the above, a second lead-out conductor 42 including the lead-out land portion Rax, the lead-out via conductor Sabx, and the lead-out via conductor Sab1 is configured. On the other hand, the lead-out via conductor Sab1 is connected to the land portion Ra1 in addition to the lead-out land portion Rax. That is, the second lead-out conductor 42 is connected to the coil 30A.

Since the insulating layer Px is laminated on the insulating layer P1 on the side opposite to the insulating layer P2, the second lead-out conductor 42 is exposed from the first end surface 11a of the element body 10A. The exposed portion of the second lead-out conductor 42 is connected to the first external electrode 21 provided on the first end surface 11a of the element body 10A. A sectional view illustrating a connection mode between the second lead-out conductor 42 and the first external electrode 21 is the same as FIG. 4, which is a sectional view illustrating a connection mode between the first lead-out conductor 41 and the first external electrode 21.

Therefore, the coil 30A and the first external electrode 21 are electrically connected via the second lead-out conductor 42.

From the above, the coil 30A is electrically connected to the same first external electrode 21 via the first lead-out conductor 41 and the second lead-out conductor 42. By the above, current paths between the coil 30A and the first external electrode 21 can be two paths of the first lead-out conductor 41 and the second lead-out conductor 42, so that current density per one lead-out conductor can be reduced. Therefore, in the laminated coil component 1, for example, when large current flows between the coil 30A and the first external electrode 21, heat generation and generation of electromigration in one lead-out conductor can be reduced as compared with a case where the coil 30A and the first external electrode 21 are electrically connected only by one lead-out conductor. In a case where the coil 30A and the first external electrode 21 are electrically connected only by one lead-out conductor, when disconnection due to heat generation and electromigration occurs in the lead-out conductor, the laminated coil component may not function. On the other hand, in the laminated coil component 1, when large current flows between the coil 30A and the first external electrode 21, heat generation and generation of electromigration in one lead-out conductor can be reduced, so that disconnection of the lead-out conductor can be prevented. Furthermore, in the laminated coil component 1, if disconnection occurs in one of the first lead-out conductor 41 and the second lead-out conductor 42, a function of the laminated coil component can be maintained by the other.

The number of the insulating layers Px may be one or more.

In a case where the number of the insulating layers Px is plural, the first lead-out conductor 41 is formed by a plurality of the lead-out land portions Rax and a plurality of the lead-out via conductors Saax connected to each other and the lead-out via conductor Saa1 that is further connected.

In a case where the number of the insulating layers Px is plural, the second lead-out conductor 42 is formed by a plurality of the lead-out land portions Rax and a plurality of the lead-out via conductors Sabx connected to each other and the lead-out via conductor Sab1 that is further connected.

The element body 10A further includes an insulating layer Py.

The insulating layer Py is laminated on the second end surface 11b side of the insulating layer P15, that is, on the side of the insulating layer P15 opposite to the insulating layer P14.

On a main surface of the insulating layer Py, a lead-out land portion Rby is provided. The lead-out land portion Rby is connected to a lead-out via conductor Sbay penetrating the insulating layers Py in the length direction L. By the above, a third lead-out conductor 43 including the lead-out land portion Rby and the lead-out via conductor Sbay is configured.

The lead-out via conductor Sbay is connected to the land portion Rb15 in addition to the lead-out land portion Rby. That is, the third lead-out conductor 43 is connected to the coil 30A.

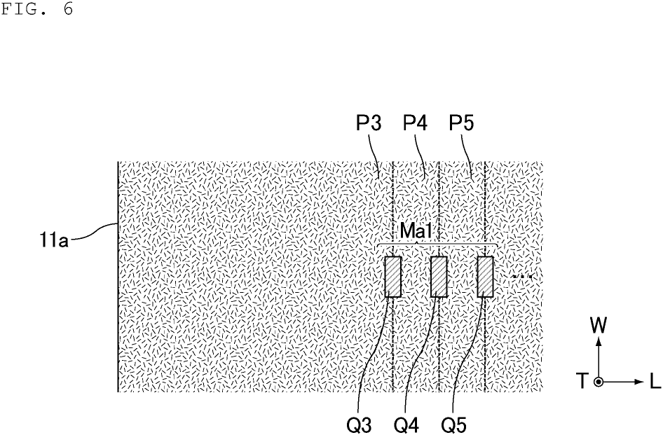

FIG. 5 is an enlarged schematic sectional view illustrating an example of a state in which the vicinity of a second end surface of the element body is viewed in a sectional view from the height direction in the laminated coil component illustrated in FIG. 1.

As illustrated in FIG. 5, since the insulating layer Py is laminated on the insulating layer P15 on the side opposite to the insulating layer P14, the third lead-out conductor 43 is exposed from the second end surface 11b of the element body 10A. The exposed portion of the third lead-out conductor 43 is connected to the second external electrode 22 provided on the second end surface 11b of the element body 10A.

Therefore, the coil 30A and the second external electrode 22 are electrically connected via the third lead-out conductor 43.

Note that, in FIG. 5, boundaries between the insulating layers are illustrated for convenience of description, but these boundaries do not clearly appear in practice.

The lead-out land portion Rby is connected to a lead-out via conductor Sbby that is provided separately from the lead-out via conductor Sbay and penetrates the insulating layer Py in the length direction L. By the above, a fourth lead-out conductor 44 including the lead-out land portion Rby and the lead-out via conductor Sbby is configured. On the other hand, the lead-out via conductor Sbby is connected to the land portion Rb15 in addition to the lead-out land portion Rby. That is, the fourth lead-out conductor 44 is connected to the coil 30A.

Since the insulating layer Py is laminated on the insulating layer P15 on the side opposite to the insulating layer P14, the fourth lead-out conductor 44 is exposed from the second end surface 11b of the element body 10A. The exposed portion of the fourth lead-out conductor 44 is connected to the second external electrode 22 provided on the second end surface 11b of the element body 10A. A sectional view illustrating a connection mode between the fourth lead-out conductor 44 and the second external electrode 22 is the same as FIG. 5, which is a sectional view illustrating a connection mode between the third lead-out conductor 43 and the second external electrode 22.

Therefore, the coil 30A and the second external electrode 22 are electrically connected via the fourth lead-out conductor 44.

From the above, the coil 30A is electrically connected to the same second external electrode 22 via the third lead-out conductor 43 and the fourth lead-out conductor 44. By the above, current paths between the coil 30A and the second external electrode 22 can be two paths of the third lead-out conductor 43 and the fourth lead-out conductor 44, so that current density per one lead-out conductor can be reduced. Therefore, in the laminated coil component 1, for example, when large current flows between the coil 30A and the second external electrode 22, heat generation and generation of electromigration in one lead-out conductor can be reduced as compared with a case where the coil 30A and the second external electrode 22 are electrically connected only by one lead-out conductor. In a case where the coil 30A and the second external electrode 22 are electrically connected only by one lead-out conductor, when disconnection due to heat generation and electromigration occurs in the lead-out conductor, the laminated coil component may not function. On the other hand, in the laminated coil component 1, when large current flows between the coil 30A and the second external electrode 22, heat generation and generation of electromigration in one lead-out conductor can be reduced, so that disconnection of the lead-out conductor can be prevented. Furthermore, in the laminated coil component 1, if disconnection occurs in one of the third lead-out conductor 43 and the fourth lead-out conductor 44, a function of the laminated coil component can be maintained by the other.

The number of the insulating layers Py may be one or more.

In a case where the number of the insulating layers Py is plural, the third lead-out conductor 43 is formed by a plurality of the lead-out land portions Rby and a plurality of the lead-out via conductors Sbay connected to each other.

In a case where the number of the insulating layers Py is plural, the fourth lead-out conductor 44 is formed by a plurality of the lead-out land portions Rby and a plurality of the lead-out via conductors Sbby connected to each other.

The numbers of the insulating layers Px and Py may be the same or different from each other.

Examples of a constituent material of each coil conductor (including a land portion), each via conductor, and each lead-out via conductor include Ag, Au, Cu, Pd, Ni, Al, and an alloy containing at least one type of the metal.

When viewed from the length direction L, each coil conductor may have a shape constituted by a straight portion as illustrated in FIGS. 2 and 3, a shape constituted by a curved portion, or a shape constituted by a straight portion and a curved portion.

When viewed from the length direction L, each land portion may have a circular shape or a polygonal shape.

When viewed from the length direction L, each via conductor may have a circular shape or a polygonal shape.

When viewed from the length direction L, each lead-out via conductor may have a circular shape or a polygonal shape.

Each coil conductor and each lead-out conductor may not independently have a land portion.

In the laminated coil component 1, a diameter of the lead-out via conductor is 100 µm or less. By the above, in a process of producing the lead-out conductor, degree of thermal shrinkage of the lead-out via conductor is reduced. For this reason, an exposed portion of the lead-out conductor exposed from a surface of the element body 10A is less likely to be recessed with respect to a surrounding insulating layer. As a result, in the laminated coil component 1, occurrence of appearance defects due to a recess of the exposed portion of the lead-out conductor is prevented.

On the other hand, in the laminated coil component 1, since the diameter of the lead-out via conductor is 100 µm or less, a sectional area of the lead-out via conductor is reduced, and as a result, there is a possibility that direct current resistance of the lead-out conductor becomes high. On the other hand, in the laminated coil component 1, as described above, since the coil 30A is electrically connected to the same external electrode via two lead-out conductors, current density per lead-out conductor can be reduced. In the laminated coil component 1, by reducing current density per lead-out conductor, if direct current resistance of the lead-out conductor becomes high, influence of the high direct current resistance can be reduced.

In the laminated coil component 1, for at least one lead-out conductor selected from a group including the first lead-out conductor 41, the second lead-out conductor 42, the third lead-out conductor 43, and the fourth lead-out conductor 44, a diameter of a lead-out via conductor constituting the lead-out conductor is preferably 100 µm or less.

In the laminated coil component 1, all the diameters of lead-out via conductors constituting the first lead-out conductor 41, the second lead-out conductor 42, the third lead-out conductor 43, and the fourth lead-out conductor 44 are particularly preferably 100 µm or less.

In the laminated coil component 1, the diameter of the lead-out via conductor is preferably 70 µm or more from the viewpoint of preventing direct current resistance of the lead-out conductor from becoming too high.

In the laminated coil component 1, for at least one lead-out conductor selected from a group including the first lead-out conductor 41, the second lead-out conductor 42, the third lead-out conductor 43, and the fourth lead-out conductor 44, a diameter of a lead-out via conductor constituting the lead-out conductor is preferably 70 µm or more.

In the laminated coil component 1, all the diameters of lead-out via conductors constituting the first lead-out conductor 41, the second lead-out conductor 42, the third lead-out conductor 43, and the fourth lead-out conductor 44 are particularly preferably 70 µm or more.

In the laminated coil component 1, a diameter of a lead-out via conductor constituting the first lead-out conductor 41 is determined as described below.

First, while the laminated coil component 1 is polished from the first side surface 13a side toward the second side surface 13b side of the element body 10A, cross sections orthogonal to the width direction W, that is, cross sections along the length direction L and the height direction T are sequentially observed along the width direction W, and a sectional image of the lead-out via conductor (including the lead-out via conductor Saax and the lead-out via conductor Saa1) constituting the first lead-out conductor 41 is photographed with a digital microscope. Next, a dimension in the height direction T of the lead-out via conductor is measured by performing image analysis with image analysis software for each photographed sectional image. Then, among dimensions in the height direction T of the lead-out via conductors measured for each sectional image, a maximum value is determined as the diameter of the lead-out via conductor constituting the first lead-out conductor 41.

Diameters of lead-out via conductors constituting the second lead-out conductor 42, the third lead-out conductor 43, and the fourth lead-out conductor 44 are also determined in the same manner as the diameter of the lead-out via conductor constituting the first lead-out conductor 41.

In the laminated coil component of the present disclosure, when a first cross section orthogonal to a direction in which the lead-out conductor extends and a second cross section orthogonal to a direction in which the coil conductor extends are determined, the sum of sectional areas of the lead-out via conductors constituting a plurality of the lead-out conductors connected to the same external electrode, which is determined by the same first cross section, is preferably equal to or more than the sum of sectional areas of the coil conductors constituting the parallel section, which is determined by the same second cross section.

In the laminated coil component 1, the first cross section orthogonal to a direction in which the lead-out conductor extends and the second cross section orthogonal to a direction in which the coil conductor extends are determined. Hereinafter, according to FIGS. 2 and 3, a cross section orthogonal to the length direction L in which the lead-out conductor extends, that is, a cross section along the height direction T and the width direction W is defined as the first cross section. Further, according to FIGS. 2 and 3, a cross section orthogonal to the height direction T in which the coil conductor extends, that is, a cross section along the length direction L and the width direction W is defined as the second cross section. Note that, as illustrated in FIGS. 2 and 3, since the coil conductor also extends in the width direction W apart from the height direction T, a cross section orthogonal to the width direction W, that is, a cross section along the length direction L and the height direction T may be defined as the second cross section.

In the laminated coil component 1, the sum of sectional areas of lead-out via conductors constituting two lead-out conductors connected to the same external electrode determined by the same first cross section is equal to or more than the sum of sectional areas of coil conductors constituting a parallel section determined by the same second cross section. More specifically, in the laminated coil component 1, the sum of a sectional area of a lead-out via conductor constituting the first lead-out conductor 41 and a sectional area of a lead-out via conductor constituting the second lead-out conductor 42, which are determined by the same first cross section, is equal to or more than the sum of sectional areas of three coil conductors constituting a parallel section, which are determined by the same second cross section. Furthermore, in the laminated coil component 1, the sum of a sectional area of a lead-out via conductor constituting the third lead-out conductor 43 and a sectional area of a lead-out via conductor constituting the fourth lead-out conductor 44, which are determined by the same first cross section, is equal to or more than the sum of sectional areas of three coil conductors constituting a parallel section, which are determined by the same second cross section. By the above, current density per lead-out conductor can be sufficiently reduced. For this reason, in the laminated coil component 1, when large current flows between the coil 30A and the external electrode, heat generation and generation of electromigration in one lead-out conductor can be reduced.

In the laminated coil component 1, for at least one of a combination of the first lead-out conductor 41 and the second lead-out conductor 42 and a combination of the third lead-out conductor 43 and the fourth lead-out conductor 44, the sum of sectional areas of lead-out via conductors determined by the same first cross-section is preferably equal to or more than the sum of sectional areas of three coil conductors constituting a parallel section determined by the same second cross-section.

In the laminated coil component 1, as described above, for both of a combination of the first lead-out conductor 41 and the second lead-out conductor 42 and a combination of the third lead-out conductor 43 and the fourth lead-out conductor 44, the sum of sectional areas of lead-out via conductors determined by the same first cross-section is particularly preferably equal to or more than the sum of sectional areas of three coil conductors constituting a parallel section determined by the same second cross-section.

In the laminated coil component 1, the sum of a sectional area of a lead-out via conductor constituting the first lead-out conductor 41 and a sectional area of a lead-out via conductor constituting the second lead-out conductor 42, which are determined by the same first cross section, is determined as described below.

First, while the laminated coil component 1 is polished from the first side surface 13a side toward the second side surface 13b side of the element body 10A, cross sections orthogonal to the width direction W, that is, cross sections along the length direction L and the height direction T are sequentially observed along the width direction W, and a sectional image of the lead-out via conductor (including the lead-out via conductor Saax and the lead-out via conductor Saa1) constituting the first lead-out conductor 41 and the lead-out via conductor (including the lead-out via conductor Sabx and the lead-out via conductor Sab1) constituting the second lead-out conductor 42 is photographed with a digital microscope. Next, a dimension in the height direction T of the lead-out via conductor constituting the first lead-out conductor 41 is measured by performing image analysis with image analysis software for each photographed sectional image. Then, a maximum value of dimensions in the height direction T of lead-out via conductors measured for each sectional image is determined as a diameter of the lead-out via conductor constituting the first lead-out conductor 41, and an equivalent circle area calculated from this diameter is determined as a sectional area of the lead-out via conductor constituting the first lead-out conductor 41. Similarly, a sectional area of the lead-out via conductor constituting the second lead-out conductor 42 is determined. Then, the sum of the sectional area of the lead-out via conductor constituting the first lead-out conductor 41 and the sectional area of the lead-out via conductor constituting the second lead-out conductor 42, which are determined by the above-described method, is determined as the sum of the sectional area of the lead-out via conductor constituting the first lead-out conductor 41 and the sectional area of the lead-out via conductor constituting the second lead-out conductor 42, which are determined by the same first cross section.

In the laminated coil component 1, the sum of a sectional area of a lead-out via conductor constituting the third lead-out conductor 43 and a sectional area of a lead-out via conductor constituting the fourth lead-out conductor 44, which are determined by the same first cross section, is also determined in the same manner as the sum of a sectional area of a lead-out via conductor constituting the first lead-out conductor 41 and a sectional area of a lead-out via conductor constituting the second lead-out conductor 42.

In the laminated coil component 1, the sum of sectional areas of three coil conductors constituting a parallel section determined by the same second cross section is determined as described below.

FIG. 6 is an enlarged schematic sectional view illustrating an example of a state in which three coil conductors constituting a parallel section are viewed in a sectional view from the height direction in the laminated coil component illustrated in FIGS. 2 and 3.

First, while the laminated coil component 1 is polished from the second main surface 12b side toward the first main surface 12a side of the element body 10A, the second cross sections along the length direction L and the width direction W are sequentially observed along the height direction T, and sectional images of the coil conductor Q3, the coil conductor Q4, and the coil conductor Q5 constituting the first parallel section Ma1 as illustrated in FIG. 6 are photographed with a digital microscope. At this time, for the coil conductor Q3, the coil conductor Q4, and the coil conductor Q5 constituting the first parallel section Ma1, a sectional image of a portion excluding a land portion is photographed. Next, for each photographed sectional image, image analysis is performed with image analysis software to measure the sum of sectional areas of the coil conductor Q3, the coil conductor Q4, and the coil conductor Q5. Then, a maximum value of the sum of sectional areas of the coil conductors measured for each sectional image is determined as the sum of sectional areas of the coil conductors constituting the first parallel section Ma1 determined by the same second cross section.

In the laminated coil component 1, a parallel section in which three coil conductors adjacent to each other overlap each other when viewed from the length direction L also exists in a section other than the first parallel section Ma1 (for example, the second parallel section Na1), but the sum of sectional areas of three coil conductors constituting a parallel section other than the first parallel section Ma1 is also determined in the same manner as the sum of sectional areas of coil conductors constituting the first parallel section Ma1.

In the laminated coil component 1, for at least one of all parallel sections, the sum of sectional areas of lead-out via conductors constituting two lead-out conductors connected to the same external electrode determined by the same first cross section is preferably equal to or more than the sum of sectional areas of three coil conductors constituting a parallel section determined by the same second cross section.

In the laminated coil component of the present disclosure, a plurality of the coil conductors laminated in the lamination direction may include an outermost coil conductor existing at an outermost position in the lamination direction, the outermost coil conductor may have a land portion at an end portion, and a plurality of the lead-out conductors are preferably connected to the same land portion.

In the laminated coil component 1, a plurality of coil conductors laminated in the length direction L include the coil conductor Q1 as an outermost coil conductor existing at an outermost position in the length direction L. The coil conductor Q1 has a land portion Ra1 at an end portion. The first lead-out conductor 41 and the second lead-out conductor 42 are connected to the same land portion Ra1.

In the laminated coil component 1, a mode in which both the first lead-out conductor 41 and the second lead-out conductor 42 are connected to the land portion Ra1 of the coil conductor Q1 which is an outermost coil conductor is exemplified, but a connection position of the first lead-out conductor 41 and the second lead-out conductor 42 with respect to the coil 30A is not limited to that in the above mode. For example, one of the first lead-out conductor 41 and the second lead-out conductor 42 may be connected to the land portion Ra1 of the coil conductor Q1, and the other may be connected to the land portion Rb1 of the coil conductor Q1. Further, one of the first lead-out conductor 41 and the second lead-out conductor 42 may be connected to the land portion Ra1 or the land portion Rb1 of the coil conductor Q1, and the other may be connected to a portion other than the land portion Ra1 and the land portion Rb1 of the coil conductor Q1. Furthermore, both the first lead-out conductor 41 and the second lead-out conductor 42 may be connected to a portion other than the land portion Ra1 and the land portion Rb1 of the coil conductor Q1.

In the laminated coil component 1, a plurality of coil conductors laminated in the length direction L include the coil conductor Q15 in addition to the coil conductor Q1 as an outermost coil conductor existing at an outermost position in the length direction L. The coil conductor Q15 has the land portion Rb15 at an end portion. The third lead-out conductor 43 and the fourth lead-out conductor 44 are connected to the same land portion Rb15.

In the laminated coil component 1, a mode in which both the third lead-out conductor 43 and the fourth lead-out conductor 44 are connected to the land portion Rb15 of the coil conductor Q15 which is an outermost coil conductor is exemplified, but a connection position of the third lead-out conductor 43 and the fourth lead-out conductor 44 with respect to the coil 30A is not limited to that in the above mode. For example, one of the third lead-out conductor 43 and the fourth lead-out conductor 44 may be connected to the land portion Rb15 of the coil conductor Q15, and the other may be connected to the land portion Ra15 of the coil conductor Q15. Further, one of the third lead-out conductor 43 and the fourth lead-out conductor 44 may be connected to the land portion Ra15 or the land portion Rb15 of the coil conductor Q15, and the other may be connected to a portion other than the land portion Ra15 and the land portion Rb15 of the coil conductor Q15. Furthermore, both the third lead-out conductor 43 and the fourth lead-out conductor 44 may be connected to a portion other than the land portion Ra15 and the land portion Rb15 of the coil conductor Q15.

The laminated coil component 1 may include only the first lead-out conductor 41 and the second lead-out conductor 42, may include only the third lead-out conductor 43 and the fourth lead-out conductor 44, or may include all of the first lead-out conductor 41, the second lead-out conductor 42, the third lead-out conductor 43, and the fourth lead-out conductor 44 as lead-out conductors.

Although the mode in which the number of coil conductors connected in parallel in a parallel section is three is exemplified above, the same applies to a mode in which the number of coil conductors connected in parallel in a parallel section is two, and furthermore, the same applies to a mode in which the number of coil conductors connected in parallel in a parallel section is four or more. Among them, from the viewpoint of reducing direct current resistance of the coil, the number of coil conductors connected in parallel in a parallel section is preferably three or more. That is, in the laminated coil component of the present disclosure, the laminated portion preferably includes three or more of the coil conductors.

Although the mode in which the number of lead-out conductors connected to the same external electrode is two is exemplified above, the same applies to a mode in which the number of lead-out conductors connected to the same external electrode is three or more.

The laminated coil component 1 is manufactured, for example, by a method below.

### Producing Process of Magnetic Material

First, Fe₂O₃, ZnO, CuO, and NiO are weighed so as to have a predetermined ratio.

Next, these weighed materials, pure water, and the like are put in a ball mill together with PSZ media, mixed, and then pulverized. Mixing and pulverizing time is, for example, four hours or more and eight hours or less (i.e., from four hours to eight hours).

Then, the obtained pulverized material is dried and then pre-fired. The pre-firing temperature is, for example, 700° C. or more and 800° C. or less (i.e., from 700° C. to 800° C.). The pre-firing time is, for example, two hours or more and five hours or less (i.e., from two hours to five hours).

In this way, a powdery magnetic material, more specifically, a powdery magnetic ferrite material is produced.

The ferrite material is preferably a Ni-Cu-Zn-based ferrite material.

The Ni-Cu-Zn-based ferrite material preferably contains Fe in an amount of 40 mol% or more and 49.5 mol% or less (i.e., from 40 mol% to 49.5 mol%) in terms of Fe₂O₃, Zn in an amount of 2 mol% or more and 35 mol% or less (i.e., from 2 mol% to 35 mol%) in terms of ZnO, Cu in an amount of 6 mol% or more and 13 mol% or less (i.e., from 6 mol% to 13 mol%) in terms of CuO, and Ni in an amount of 10 mol% or more and 45 mol% or less (i.e., from 10 mol% to 45 mol%) in terms of NiO when the total amount is 100 mol%.

The Ni-Cu-Zn-based ferrite material may further contain an additive such as Co, Bi, Sn, or Mn.

The Ni-Cu-Zn-based ferrite material may further contain inevitable impurities.

### Producing Process of Green Sheet

First, a magnetic material, an organic binder such as polyvinyl butyral-based resin, an organic solvent such as ethanol or toluene, a plasticizer, and the like are put in a ball mill together with PSZ media and mixed, and then pulverized to produce slurry.

Next, the slurry is formed into a sheet shape having a predetermined thickness by a doctor blade method or the like, and then punched into a predetermined shape to produce a green sheet. The thickness of the green sheet is, for example, 20 µm or more and 30 µm or less (i.e., from 20 µm to 30 µm). The shape of the green sheet is, for example, a rectangular shape.

As a material of the green sheet, a nonmagnetic material such as a borosilicate glass material may be used instead of the magnetic material, or a mixed material of the magnetic material and the nonmagnetic material may be used.

### Formation Process of Conductor Pattern

First, a predetermined portion of the green sheet is irradiated with a laser to form a via hole.

Next, conductive paste such as Ag paste is applied to a surface of the green sheet while the via hole is filled with the conductive paste by a screen printing method or the like. By the above, a conductor pattern for a coil conductor connected to a conductor pattern for a via conductor is formed on a surface of the green sheet while the conductor pattern for a via conductor is formed in the via hole. In this way, a coil sheet in which the conductor pattern for a coil conductor and the conductor pattern for a via conductor are formed on the green sheet is produced. A plurality of the coil sheets are prepared, and a conductor pattern for a coil conductor corresponding to the coil conductor illustrated in FIGS. 2 and 3 and a conductor pattern for a via conductor corresponding to a via conductor (including the lead-out via conductor Saa1 and the lead-out via conductor Sab1 illustrated in FIGS. 2 and 3) connected to the coil conductor illustrated in FIGS. 2 and 3 are formed for each of the coil sheets.

Further, conductive paste such as Ag paste is applied to a surface of the green sheet while the via hole is filled with the conductive paste by a screen printing method or the like. By the above, a conductor pattern for a land portion connected to a conductor pattern for a via conductor is formed on a surface of the green sheet while the conductor pattern for a via conductor is formed in the via hole. In this way, a via sheet in which the conductor pattern for a land portion and the conductor pattern for a via conductor are formed on the green sheet is produced separately from a coil sheet. A plurality of the via sheets are also prepared, and a conductor pattern for a land portion corresponding to the lead-out land portion constituting the lead-out conductor illustrated in FIGS. 2 and 3 and a conductor pattern for a via conductor corresponding to the lead-out via conductor (excluding the lead-out via conductor Saa1 and the lead-out via conductor Sab1 illustrated in FIGS. 2 and 3) connected to the lead-out land portion illustrated in FIGS. 2 and 3 are formed on each of the via sheets.

When the coil sheet and the via sheet are produced, a maximum diameter of a conductor pattern for a via conductor to be a lead-out via conductor later is set to 100 µm or less after firing described later.

### Producing Process of Laminate Block

The coil sheet and the via sheet are laminated in the lamination direction (the length direction L in FIGS. 2 and 3) in the order corresponding to FIGS. 2 and 3, and then thermocompression-bonded to produce a laminate block.

### Producing Process of Element Body and Coil

First, the laminated body block is cut into predetermined size with a dicer or the like to produce a chip as an individual piece.

Next, the chip as an individual piece is fired. The firing temperature is, for example, 900° C. or more and 920° C. or less (i.e., from 900° C. to 920° C.). The firing time is, for example, two hours or more and four hours or less (i.e., from two hours to four hours).

When the chip as an individual piece is fired, the green sheets of the coil sheet and the via sheet become insulating layers. As a result, an element body formed of a plurality of the insulating layers laminated in the lamination direction (the length direction L in FIGS. 2 and 3) is produced.

When the chip as an individual piece is fired, the conductor pattern for a coil conductor and the conductor pattern for a via conductor of the coil sheet become a coil conductor and a via conductor (including the lead-out via conductor Saa1 and the lead-out via conductor Sab1 illustrated in FIGS. 2 and 3), respectively. As a result, a coil in which a plurality of the coil conductors laminated in the lamination direction (the length direction L in FIGS. 2 and 3) are electrically connected via the via conductor is produced.

As described above, the element body and the coil provided inside the element body are produced.

On the other hand, when the chip as an individual piece is fired, the conductor pattern for a land portion and the via conductor pattern of the via sheet become the lead-out land portion and the lead-out via conductor, respectively. As a result, the first lead-out conductor, the second lead-out conductor, the third lead-out conductor, and the fourth lead-out conductor formed of a plurality of lead-out land portions and a plurality of lead-out via conductors laminated in the lamination direction (the length direction L in FIGS. 2 and 3) and connected alternately are produced. The first lead-out conductor and the second lead-out conductor are exposed from the first end surface of the element body. The third lead-out conductor and the fourth lead-out conductor are exposed from the second end surface of the element body.

The element body may be subjected to, for example, barrel polishing so that a corner portion and a ridge portion are rounded.

### Forming Process of External Electrode

First, by applying conductive paste such as paste containing Ag and glass frit, a first coating film connected to the first lead-out conductor and the second lead-out conductor exposed from the first end surface of the element body is formed so as to extend from the first end surface of the element body over a part of each of the first main surface, the second main surface, the first side surface, and the second side surface.

Further, by applying conductive paste such as paste containing Ag and glass frit, a second coating film connected to the third lead-out conductor and the fourth lead-out conductor exposed from the second end surface of the element body is formed so as to extend from the second end surface of the element body over a part of each of the first main surface, the second main surface, the first side surface, and the second side surface.

In this way, the first coating film and the second coating film are formed at positions separated from each other on a surface of the element body.

When the first coating film and the second coating film are formed, the first coating film and the second coating film may be formed at different timings, or may be formed at the same timing.

In a case where the first coating film and the second coating film are formed at different timings, the first coating film and the second coating film may be formed in this order, or the second coating film and the first coating film may be formed in this order.

Next, by baking the first coating film, a first base electrode extending from the first end surface of the element body over a part of each of the first main surface, the second main surface, the first side surface, and the second side surface and connected to the first lead-out conductor and the second lead-out conductor is formed.

Further, by baking the second coating film, a second base electrode extending from the second end surface of the element body over a part of each of the first main surface, the second main surface, the first side surface, and the second side surface and connected to the third lead-out conductor and the fourth lead-out conductor is formed.

The baking temperature of the first coating film and the second coating film is, for example, 800° C. or more and 820° C. or less (i.e., from 800° C. to 820° C.).

The thickness of the first base electrode and the second base electrode is, for example, 5 µm.

Then, a Ni plated electrode and a Sn plated electrode are formed in order on a surface of the first base electrode by electrolytic plating or the like. By the above, the first external electrode including the first base electrode, the Ni plated electrode, and the Sn plated electrode in order from the surface side of the element body is formed.

A Ni plated electrode and a Sn plated electrode are formed in order on a surface of the second base electrode by electrolytic plating or the like. By the above, the second external electrode including the second base electrode, the Ni plated electrode, and the Sn plated electrode in order from the surface side of the element body is formed.

In this way, the first external electrode electrically connected to the coil via the first lead-out conductor and the second lead-out conductor, and the second external electrode electrically connected to the coil via the third lead-out conductor and the fourth lead-out conductor are formed on a surface of the element body.

As described above, the laminated coil component 1 is manufactured.

### [Example]

Hereinafter, an example specifically disclosing the laminated coil component of the present disclosure will be described. Note that the present disclosure is not limited only to the example below.

### [First Example]

The laminated coil component of a first example was manufactured by a method below.

### Producing Process of Magnetic Material

First, Fe₂O₃, ZnO, CuO, and NiO were weighed so as to have a predetermined ratio.

Next, these weighed materials, pure water, and the like were put in a ball mill together with PSZ media, mixed, and then pulverized. The mixing and pulverization time was set to six hours.

Then, the obtained pulverized material was dried and then pre-fired. The pre-firing temperature was set to 800° C. The pre-firing time was set to three hours.

In this way, a powdery magnetic material, more specifically, a powdery magnetic ferrite material was produced.

### Producing Process of Green Sheet

First, a magnetic material, polyvinyl butyral-based resin as an organic binder, ethanol and toluene as organic solvents, and a plasticizer were put in a ball mill together with PSZ media, mixed, and then pulverized to produce slurry.

Next, the slurry was formed into a sheet by a doctor blade method and then punched to prepare a green sheet. The thickness of the green sheet was set to 25 µm. The shape of the green sheet was set to a rectangular shape.

### Formation Process of Conductor Pattern

First, a predetermined portion of the green sheet was irradiated with a laser to form a via hole.

Next, Ag paste was applied to a surface of the green sheet while the via hole was filled with Ag paste by a screen printing method or the like. By the above, a conductor pattern for a coil conductor connected to a conductor pattern for a via conductor was formed on a surface of the green sheet while the conductor pattern for a via conductor is formed in the via hole. In this way, a coil sheet in which the conductor pattern for a coil conductor and the conductor pattern for a via conductor are formed on the green sheet was produced. A plurality of the coil sheets were prepared, and a conductor pattern for a coil conductor corresponding to the coil conductor illustrated in FIGS. 2 and 3 and a conductor pattern for a via conductor corresponding to a via conductor (including the lead-out via conductor Saa1 and the lead-out via conductor Sab1 illustrated in FIGS. 2 and 3) connected to the coil conductor illustrated in FIGS. 2 and 3 were formed for each of the coil sheets.

When the coil sheet was produced, a dimension in the length direction and a dimension in the width direction of the conductor pattern for a coil conductor were set to 17.5 µm and 200 µm, respectively, after firing described later.

Further, Ag paste was applied to a surface of the green sheet while the via hole was filled with Ag paste by a screen printing method or the like. By the above, a conductor pattern for a land portion connected to a conductor pattern for a via conductor was formed on a surface of the green sheet while the conductor pattern for a via conductor was formed in the via hole. In this way, a via sheet in which the conductor pattern for a land portion and the conductor pattern for a via conductor are formed on the green sheet was produced separately from a coil sheet. A plurality of the via sheets were also prepared, and a conductor pattern for a land portion corresponding to the lead-out land portion constituting the lead-out conductor illustrated in FIGS. 2 and 3 and a conductor pattern for a via conductor corresponding to the lead-out via conductor (excluding the lead-out via conductor Saa1 and the lead-out via conductor Sab1 illustrated in FIGS. 2 and 3) connected to the lead-out land portion illustrated in FIGS. 2 and 3 were formed on each of the via sheets.

When the coil sheet and the via sheet were produced, a diameter of a conductor pattern for a via conductor to be a lead-out via conductor later was set to 92 µm after firing described later.

### Producing Process of Laminate Block

The coil sheet and the via sheet were laminated in the lamination direction (the length direction L in FIGS. 2 and 3) in the order corresponding to FIGS. 2 and 3, and then thermocompression-bonded to produce a laminate block.

### Producing Process of Element Body and Coil

First, the laminated body block was cut into predetermined size with a dicer to produce a chip as an individual piece.

Next, the chip as an individual piece was fired. The firing temperature was set to 900° C. The firing time was set to three hours.

When the chip as an individual piece was fired, the green sheets of the coil sheet and the via sheet became insulating layers. As a result, an element body formed of a plurality of the insulating layers laminated in the lamination direction (the length direction L in FIGS. 2 and 3) was produced.

When the chip as an individual piece was fired, the conductor pattern for a coil conductor and the conductor pattern for a via conductor of the coil sheet became a coil conductor and a via conductor (including the lead-out via conductor Saa1 and the lead-out via conductor Sab1 illustrated in FIGS. 2 and 3), respectively. As a result, a coil in which a plurality of the coil conductors laminated in the lamination direction (the length direction L in FIGS. 2 and 3) were electrically connected via the via conductor is produced.

As described above, the element body and the coil provided inside the element body were produced.

On the other hand, when the chip as an individual piece was fired, the conductor pattern for a land portion and the via conductor pattern of the via sheet became the lead-out land portion and the lead-out via conductor, respectively. As a result, the first lead-out conductor, the second lead-out conductor, the third lead-out conductor, and the fourth lead-out conductor formed of a plurality of lead-out land portions and a plurality of lead-out via conductors laminated in the lamination direction (the length direction L in FIGS. 2 and 3) and connected alternately were produced. The first lead-out conductor and the second lead-out conductor were exposed from the first end surface of the element body. The third lead-out conductor and the fourth lead-out conductor were exposed from the second end surface of the element body.

Then, the element body was placed in a rotary barrel machine together with a medium, and the element body was subjected to barrel polishing so that a corner portion and a ridge portion are rounded.

### Forming Process of External Electrode

First, by applying conductive paste containing Ag and glass frit, a first coating film connected to the first lead-out conductor and the second lead-out conductor exposed from the first end surface of the element body was formed so as to extend from the first end surface of the element body over a part of each of the first main surface, the second main surface, the first side surface, and the second side surface.

Further, by applying conductive paste containing Ag and glass frit, a second coating film connected to the third lead-out conductor and the fourth lead-out conductor exposed from the second end surface of the element body was formed so as to extend from the second end surface of the element body over a part of each of the first main surface, the second main surface, the first side surface, and the second side surface.

In this way, the first coating film and the second coating film were formed at positions separated from each other on a surface of the element body.

Next, by baking the first coating film, the first base electrode extending from the first end surface of the element body over a part of each of the first main surface, the second main surface, the first side surface, and the second side surface and connected to the first lead-out conductor and the second lead-out conductor was formed.

Further, by baking the second coating film, the second base electrode extending from the second end surface of the element body over a part of each of the first main surface, the second main surface, the first side surface, and the second side surface and connected to the third lead-out conductor and the fourth lead-out conductor was formed.

The baking temperature of the first coating film and the second coating film was set to 800° C.

The thickness of the first base electrode and the second base electrode was set to 5 µm.

Then, a Ni plated electrode and a Sn plated electrode were formed in order on a surface of the first base electrode by electrolytic plating. By the above, the first external electrode including the first base electrode, the Ni plated electrode, and the Sn plated electrode in order from the surface side of the element body was formed.

Further, a Ni plated electrode and a Sn plated electrode were formed in order on a surface of the second base electrode by electrolytic plating. By the above, the second external electrode including the second base electrode, the Ni plated electrode, and the Sn plated electrode in order from the surface side of the element body was formed.

In this way, the first external electrode electrically connected to the coil via the first lead-out conductor and the second lead-out conductor, and the second external electrode electrically connected to the coil via the third lead-out conductor and the fourth lead-out conductor were formed on a surface of the element body.

As described above, the laminated coil component 1 of the first example was manufactured.

The laminated coil component of the first example had a dimension of 2.0 mm in the length direction, a dimension of 1.25 mm in the height direction, and a dimension of 1.25 mm in the width direction.

In the laminated coil component of the first example, all diameters of the lead-out via conductors constituting the first lead-out conductor, the second lead-out conductor, the third lead-out conductor, and the fourth lead-out conductor were 92 µm. That is, in the laminated coil component of the first example, the sum of a sectional area of a lead-out via conductor constituting the first lead-out conductor and a sectional area of a lead-out via conductor constituting the second lead-out conductor, which are determined by the same first cross section along the height direction and the width direction, was about 13300 µm². Further, in the laminated coil component of the first example, the sum of a sectional area of a lead-out via conductor constituting the third lead-out conductor and a sectional area of a lead-out via conductor constituting the fourth lead-out conductor, which are determined by the same first cross section along the height direction and the width direction, was about 13300 µm².

In the laminated coil component of the first example, a dimension in the length direction of all the coil conductors was 17.5 µm, and a dimension in the width direction of all the coil conductors was 200 µm. That is, in the laminated coil component of the first example, the sum of sectional areas of three coil conductors constituting a parallel section determined by the same second cross section along the length direction and the width direction was 10500 µm².

From the above, in the laminated coil component of the first example, the sum of a sectional area of a lead-out via conductor constituting the first lead-out conductor and a sectional area of a lead-out via conductor constituting the second lead-out conductor, which are determined by the same first cross section, was equal to or more than the sum of sectional areas of three coil conductors constituting a parallel section, which are determined by the same second cross section. Further, in the laminated coil component of the first example, the sum of a sectional area of a lead-out via conductor constituting the third lead-out conductor and a sectional area of a lead-out via conductor constituting the fourth lead-out conductor, which are determined by the same first cross section, was equal to or more than the sum of sectional areas of three coil conductors constituting a parallel section, which are determined by the same second cross section.

### [First Comparative Example]

A laminated coil component of a first comparative example was produced in the same manner as the laminated coil component of the first example except that the second lead-out conductor and the fourth lead-out conductor were not produced.

In the laminated coil component of the first comparative example, all diameters of lead-out via conductors constituting the first lead-out conductor and the third lead-out conductor were 130 µm. That is, in the laminated coil component of the first comparative example, a sectional area of the lead-out via conductor constituting the first lead-out conductor determined by the first cross section along the height direction and the width direction was about 13300 µm². Further, in the laminated coil component of the first comparative example, a sectional area of the lead-out via conductor constituting the third lead-out conductor determined by the first cross section along the height direction and the width direction was about 13300 µm².

In the laminated coil component of the first comparative example, similarly to the laminated coil component of the first example, dimensions in the length direction of all the coil conductors were 17.5 µm, and dimensions in the width direction of all the coil conductors were 200 µm. That is, in the laminated coil component of the first comparative example, similarly to the laminated coil component of the first example, the sum of sectional areas of three coil conductors constituting a parallel section determined by the same second cross section along the length direction and the width direction was 10500 µm².

### [Evaluation]

First, the periphery of each of the laminated coil component of the first example and the laminated coil component of the first comparative example was sealed with resin in a state where the second main surface of the element body was erected vertically so as to be exposed to the upper side. Then, each of the laminated coil components was polished with a polishing machine in the height direction from the second main surface side toward the first main surface side of the element body until a lead-out conductor was exposed. After the above, the lead-out conductor in a cross section along the length direction and the width direction of each of the laminated coil components was observed with a digital microscope.

In the laminated coil component of the first example in which a diameter of the lead-out via conductor was 100 µm or less, exposed portions of the first lead-out conductor and the second lead-out conductor exposed from the first end surface of the element body were not significantly recessed with respect to a surrounding insulating layer, and occurrence of appearance defects due to the recess of the exposed portions of the lead-out conductor was reduced. Further, in the laminated coil component of the first example, exposed portions of the third lead-out conductor and the fourth lead-out conductor exposed from the second end surface of the element body were not significantly recessed with respect to a surrounding insulating layer, and occurrence of appearance defects due to the recess of the exposed portions of the lead-out conductor was reduced.

Furthermore, in the laminated coil component of the first example in which the sum of a sectional area of a lead-out via conductor constituting the first lead-out conductor and a sectional area of a lead-out via conductor constituting the second lead-out conductor determined by the same first cross section is equal to or more than the sum of sectional areas of three coil conductors constituting a parallel section determined by the same second cross section, current density per lead-out conductor was confirmed to be sufficiently low.

In the laminated coil component of the first comparative example in which a diameter of the lead-out via conductor is larger than 100 µm, an exposed portion of the first lead-out conductor exposed from the first end surface of the element body was significantly recessed with respect to a surrounding insulating layer, and occurrence of appearance defects due to the recess of the exposed portion of the lead-out conductor was not reduced. Further, in the laminated coil component of the first comparative example, an exposed portion of the third lead-out conductor exposed from the second end surface of the element body was significantly recessed with respect to a surrounding insulating layer, and occurrence of appearance defects due to the recess of the exposed portion of the lead-out conductor was not reduced.

What is claimed is:

1. A laminated coil component comprising:
an element body including a plurality of insulating layers laminated in a lamination direction;
a coil inside the element body; and
an external electrode on a surface of the element body and electrically connected to the coil, wherein
the coil includes a plurality of coil conductors laminated in the lamination direction and electrically connected via a via conductor penetrating the insulating layer in the lamination direction,
the plurality of coil conductors laminated in the lamination direction includes a laminated portion including the plurality of coil conductors adjacent to each other,
the laminated portion has a parallel section in which all the coil conductors constituting the laminated portion overlap each other when viewed from the lamination direction,
the parallel sections are connected in parallel by the via conductor,
the coil is electrically connected to a same external electrode via a plurality of lead-out conductors,
each of the lead-out conductors includes a lead-out via conductor penetrating the insulating layer in the lamination direction, and
a diameter of the lead-out via conductor is 100 µm or less.

2. The laminated coil component according to claim 1, wherein
when a first cross section orthogonal to a direction in which the lead-out conductor extends and a second cross section orthogonal to a direction in which the coil conductor extends are determined, a first sum of sectional areas of the lead-out via conductors constituting the plurality of lead-out conductors connected to the same external electrode, the first sum being determined by a same first cross section, is equal to or greater than a second sum of sectional areas of the coil conductors constituting the parallel section, the second sum being determined by a same second cross section.

3. The laminated coil component according to claim 1, wherein
the plurality of coil conductors laminated in the lamination direction includes an outermost coil conductor located at an outermost position in the lamination direction,
the outermost coil conductor includes a land portion at an end portion thereof, and
the plurality of lead-out conductors are connected to a same land portion.

4. The laminated coil component according to claim 1, wherein
the laminated portion includes three or more of the coil conductors.

5. The laminated coil component according to claim 1, wherein
the lamination direction and a direction of a coil axis of the coil are parallel to a mounting surface of the element body along a same direction.

6. The laminated coil component according to claim 1, wherein
each length of all the coil conductors constituting the laminated portion is a length of ¾ turns of the coil.

7. The laminated coil component according to claim 2, wherein
the plurality of coil conductors laminated in the lamination direction includes an outermost coil conductor located at an outermost position in the lamination direction,
the outermost coil conductor includes a land portion at an end portion thereof, and
the plurality of lead-out conductors are connected to a same land portion.

8. The laminated coil component according to claim 2, wherein
the laminated portion includes three or more of the coil conductors.

9. The laminated coil component according to claim 3, wherein
the laminated portion includes three or more of the coil conductors.

10. The laminated coil component according to claim 7, wherein
the laminated portion includes three or more of the coil conductors.

11. The laminated coil component according to claim 2, wherein
the lamination direction and a direction of a coil axis of the coil are parallel to a mounting surface of the element body along a same direction.

12. The laminated coil component according to claim 3, wherein
the lamination direction and a direction of a coil axis of the coil are parallel to a mounting surface of the element body along a same direction.

13. The laminated coil component according to claim 4, wherein
the lamination direction and a direction of a coil axis of the coil are parallel to a mounting surface of the element body along a same direction.

14. The laminated coil component according to claim 7, wherein
the lamination direction and a direction of a coil axis of the coil are parallel to a mounting surface of the element body along a same direction.

15. The laminated coil component according to claim 8, wherein
the lamination direction and a direction of a coil axis of the coil are parallel to a mounting surface of the element body along a same direction.

16. The laminated coil component according to claim 2, wherein
each length of all the coil conductors constituting the laminated portion is a length of ¾ turns of the coil.

17. The laminated coil component according to claim 3, wherein
each length of all the coil conductors constituting the laminated portion is a length of ¾ turns of the coil.

18. The laminated coil component according to claim 4, wherein
each length of all the coil conductors constituting the laminated portion is a length of ¾ turns of the coil.

19. The laminated coil component according to claim 5, wherein
each length of all the coil conductors constituting the laminated portion is a length of ¾ turns of the coil.

20. The laminated coil component according to claim 7, wherein
each length of all the coil conductors constituting the laminated portion is a length of ¾ turns of the coil.
